(19) United States
(12) Patent Application Publication
(10) Pub. No.: US 2007/0130189 A1
(43) Pub. Date: Jun. 7, 2007

(54) Method of creating a description document in markup language of a global service provided on a communication path

(75) Inventors: Jean-Jacques Moreau, Rennes (FR); Youenn Fablet, La Dominelais (FR)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/545,610

(22) PCT Filed: Mar. 3, 2004
(86) PCT No.: PCT/IB04/00935

§ 371 Date: Oct. 16, 2006

(30) Foreign Application Priority Data
Mar. 3, 2003 (FR) 0302578

(51) Int. Cl. G06F 7/00

(52) U.S. Cl. 707/102

(57) ABSTRACT

A method of creating a description document in markup language of a global service provided by at least two successive nodes on a communication path in the communication network, using description documents of a unitary service provided by each of said nodes on the communication path, each description document of a unitary service provided by a node comprising a list of blocks received by said node when said unitary service is implemented, comprises a step (E306) of determining a set of blocks comprising the combining of the blocks received by each node on the communication path when the global service is implemented; a step (E305, E307, E308) of entering a first tag including said combining of the blocks received; a step (E314-E316, E318) of determining, for each node, the processing or processings associated respectively with the blocks of said combining of the received blocks; and a step (E317, E319) of entering a second tag specifying the processing or processings associated with said blocks at each node on the communication path. Use for describing a global service on a communication path in a network.

The present invention concerns a method of creating a document in markup language of a global service provided by at least two successive nodes on a communication path in a communication network.

It also concerns a method of identifying blocks to be included in a message, a method of discovering work carried out by an intermediate node in the communication network and a method of discovering blocks sent by an intermediate node in the communication network.

It also concerns a description document in markup language of a global service provided by at least two successive nodes on a communication path in a communication network.

Finally, it concerns a method of creating a description document in markup language of a partial service provided by an intermediate node on a communication path.

Within a computer communication network of the Internet type, server computers are more and more often offering services to other computers, referred to as client computers, in this communication network.

In practice, the client computer sends a message comprising data to the server computer, which processes the data and returns a result.

Such services are known as Web services.

Because of the increase in these services available on a communication network, the protocols for data exchanges between computers are frequently standardized.

Thus the SOAP protocol is a protocol for exchanging structured information on top of the Internet.

According to the SOAP protocol, the information exchanged is structured by means of XML (the acronym for the English term “eXtended Mark-up Language”) tags.

SOAP is a communication protocol which makes it possible thus to access remote services.

The SOAP standard defines the general structure of the messages exchanged as well as processing steps, which have to be carried out by a computer sending or receiving SOAP messages.

A SOAP message is composed of one or more blocks, in two major categories: header blocks encapsulated in a <header> tag and body blocks encapsulated in a <body> tag.

These blocks are intended either for a final receiver, for example a server providing a service, or one of the intermediate nodes in the communication network disposed on a communication path during the transfer of the message from the sender to the receiver.

Each block is address to a node in the network by means of an attribute “ROLE”, which can thus be specified independently for each block of the message.

The value of this attribute is either the electronic address of the intermediary (for example: http://example.org/intermed1), or the definition of the role played by this intermediary (for example “cash manager”).

A computer service description language WSDL (the acronym of the English term “Web Service Description Language”), which makes it possible to describe Internet services, and in particular services defined by the SOAP standard, is also known.

A WSDL document thus contains a list of the services offered by a server computer in a communication network.

This WSDL language is itself an application of the XML markup language.

A description of the WSDL 1.1 language will be found on the website at the address http://www.w3.org/TR/2001/NOTE-wsdl-20010315.

In practice, an electronic document describing a service in WSDL language comprises two parts.

A first part, called the “abstract part”, is adapted to describe the messages exchanged between computers in the communication network when a service is being provided.

In particular, this first part defines the type of data exchanged, the type of message used when the service is executed, and the operations implemented, defined by the messages which are exchanged during the execution of the service.

An operation can therefore be seen as an elementary service, itself implemented by one or more messages in a logical sequence of organization of the messages.

The description document of a WSDL service also comprises a second part adapted to define information relating to the transmission of the messages on the communication network.

It makes it possible to indicate in particular how the messages are encoded in order to be transmitted on the network and which communication protocol is actually used.

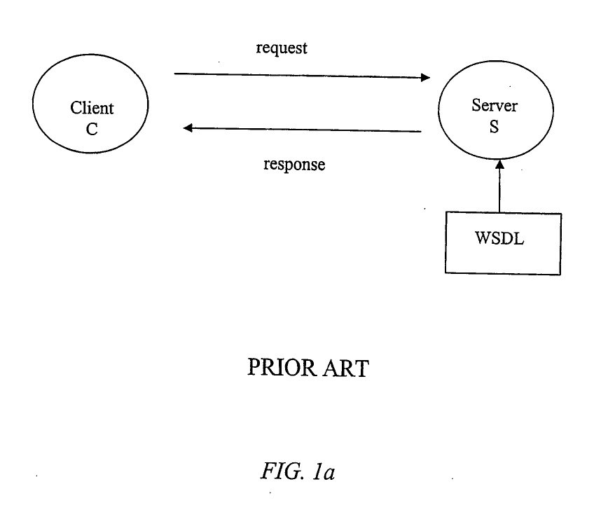

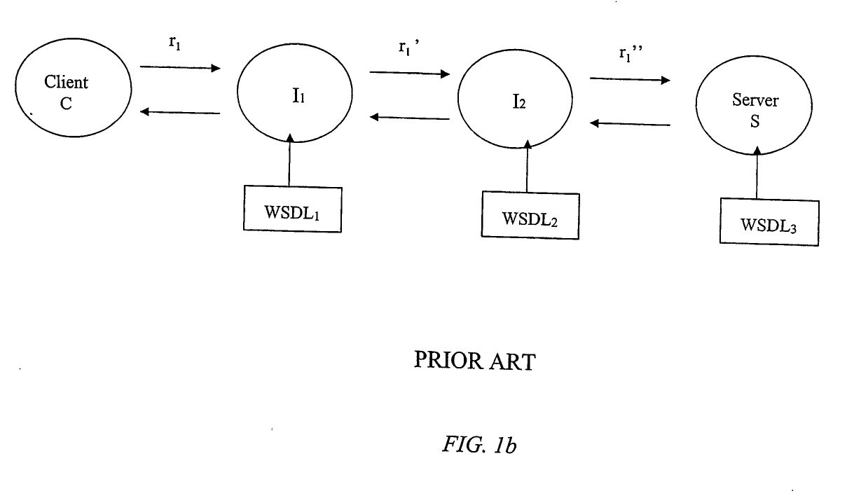

FIG. 1a thus depicts a conventional scheme of use of a WSDL document, in the absence of any intermediary between a client computer and a server computer in the communication network.

The client computer thus communicates with the server computer by means of requests and responses.

The type and content of these messages, and the order of exchange thereof, are described in a unique WSDL file stored at the server computer.

However, conventionally, in a communication network, the messages are intended to pass over a communication channel comprising several successive nodes for relaying the messages from the client computer to the server computer and vice-versa.

FIG. 1b thus depicts a conventional diagram of such a communication network, in which two intermediate computers I1 and I2, adapted to modify the messages sent by the client computer and the server computer, are disposed on the communication path between the client computer and the server computer.

In the current state of the art, three description documents of a service WSDL1, WSDL2 and WSDL3 are necessary for describing the services provided in a unitary fashion by the server computer R and the intermediate nodes I1 and I2.

In such a situation, each description document of a unitary service WSDL1, WSDL2 and WSDL3 comprises a list of the blocks received by each node I1, I2, S when the unitary service is implemented, as if each node were supplying an independent service.

The aim of the present invention is to resolve the aforementioned drawbacks and to propose an improved service description document.

The present invention relates, according to a first aspect, to a method of creating a description document in markup language of a global service provided by at least two successive nodes on a communication path in the communication network, from description documents of a unitary service supplied by each of the said nodes on the communication path, each description document of a unitary service supplied by a node comprising a list of blocks received by said node when said unitary service is implemented.

According to the invention, this creation method comprises the following steps:
determining a set of blocks comprising the combination of the blocks received by each node on the communication path when the global service is implemented;
entering a first tag including the said combination of the blocks received;
determining for each node the processing or processings associated respectively with the blocks of said combination of the blocks received; and
entering a second tag specifying the processing or processings associated with said blocks at each node on the communication path.

It is thus possible to create, from unitary service description documents supplied by each node in a communication network, a unique document for notionally describing a global service supplied on the communication network, by grouping together all the blocks passing over a communication path when the service is executed.

According to a preferred characteristic of the invention, the step of determining the processing or processings comprises, for each node on the communication path, the following steps:
reading the list of blocks received by said node from the unitary service description document associated with said node;
calculating a subset of blocks comprising the combination of the blocks received by the nodes following said node in the communication path; and
identifying the blocks in the list not belonging to said subset of blocks so as to determine the blocks consumed by said node.

Amongst the processings which can be implemented at a communication node, it is possible to define and enter in the description document of a global service according to the invention all the blocks consumed by each node on the communication path.

According to another preferred characteristic of the invention, the step of determining the processing or processings comprises, for each node on the communication path, the following steps:
reading the list of blocks received by said node from the unitary service description document associated with said node;
calculating a subset of blocks comprising the combination of the blocks received by the nodes following said node in the communication path; and
identifying the blocks in said subset of blocks not belonging to said list of blocks received by said node so as to determine the blocks produced by said node on the communication path.

As before, it is possible to identify and enter in the description document of a global service according to the invention all the blocks produced by each node on the communication path.

The second tag is preferably adapted to specify a processing chosen from amongst the production of a block, the consumption of a block or the transformation of a block of a message passing over the communication path.

In practice, when the global service provided comprises several messages passing over the communication path, the method of creating a description document or a global service comprises, for each message described in the document, a step of entering a first tag including the combination of the blocks received during the transfer of said message and a step of entering a second tag specifying the processing or processings associated with said blocks of said combination at each node on the communication path.

In order to associate, for each message of the global service, the description of the blocks and the associated processings, the second tag is associated with a reference identifying said first tag for each message described in the description document in markup language.

According to another aspect of the invention, it concerns a method of identifying the blocks to be included in a message intended to pass over a communication path comprising at least two successive nodes of the communication network, from a description document of a global service supplied on said communication path.

According to the invention, this method of identifying the blocks comprises the following steps:
determining all the blocks consumed by each node on the communication path;
determining all the blocks produced by each node on the communication path; and
identifying the blocks in said set of blocks consumed which do not belong to said set of blocks produced so as to determine the blocks to be entered in the message.

By virtue of the description document of a global service according to the invention, it is possible to identify, at a client computer, the blocks which are to be sent in a message to a server computer when this message is intended to pass over several intermediate nodes in the communication network.

According to a third aspect of the invention, it concerns a method of discovering work carried out by a node on a communication path in a communication network, from a description document of a global service supplied on said communication path.

This method of discovering work comprises the following steps:
reading for said node the processing or processings and said blocks associated with these processings specified in a tag of the description document of a global service;
reading the definition of said read blocks specified in another tag of the description document of a global service; and
supplying a response including the list of the read blocks associated respectively with said definitions.

It is thus possible, at each node in a communication network, to display the work performed by this node, when a global service is implemented on the communication network.

According to a fourth aspect of the invention, it concerns a method of identifying the blocks sent by an intermediate node on a communication path in a communication network, from a description document of a global service supplied on said communication path.

This method of identifying the blocks sent by an intermediate node comprises the following steps:
determining the blocks sent by a sender according to the method of identifying the blocks to be included in a message according to the second aspect of the present invention;
determining all the blocks produced by nodes prior to said intermediate node on the communication path;
determining all the blocks consumed by said nodes prior to said intermediate node on the communication path;
determining said blocks produced by said intermediate node on the communication path;
determining said blocks consumed by said intermediate node on the communication path; and
identifying the blocks belonging to a first set containing all the blocks sent by the sender, the blocks produced by said prior nodes, and the blocks produced by said intermediate node, and not belonging to a second set containing all the blocks consumed by said prior nodes and the blocks consumed by said intermediate node, so as to determine the blocks sent by said intermediate node.

According to a fifth aspect, the invention concerns a description document in markup language of a global service supplied by at least two successive nodes on a communication path in the communication network.

According to the invention, this description document in markup language of a global service comprises a first tag comprising the combination of the blocks received by each node and a second tag specifying respectively, for said blocks, the processing or processings implemented and the identification of said node on the communication path adapted to process said block.

According to a preferred characteristic, the processing is chosen from amongst the production of a block, the consumption of a block or the transformation of a block of a message passing over the communication path.

This description document according to the invention thus makes it possible to describe the processings implemented according to the SOAP standard by the various nodes in a communication network.

According to one advantageous characteristic of the invention, the second tag is associated with a reference identifying a first tag, so that, for each message described in this description document, the first tag, describing in an abstract manner the blocks exchanged during the transfer of a message on the communication network, can be associated with a second tag defining the processings and the place of these processings for each of the blocks in the message.

This description document according to the invention is thus presented in a format of the WSDL type and thus corresponds to a description document of an improved WSDL service.

According to a sixth aspect, the invention also concerns a method of creating a description document in markup language of a partial service supplied by an intermediate node on a communication path in a communication network when a global service supplied by at least two successive nodes on said communication path is implemented, from description documents of a unitary service provided by each node on the communication path, each description document of a unitary service provided by a node comprising a list of blocks received by said node when said unitary service is implemented.

This method of creating a description document in markup language of a partial service comprises the following steps:
reading the list of blocks received by said intermediate node from the description document of a unitary service associated with said intermediate node;
calculating a subset of blocks comprising the combination of the blocks received by the nodes following said intermediate node in the communication path;
identifying the blocks in said list of blocks received by said intermediate node not belonging to said subset of blocks so as to determine the blocks consumed by said intermediate node; and
entering a first tag including said blocks consumed by said intermediate node.

According to a variant of this sixth aspect of the invention, this method of creating a document also comprises the following steps:
identifying the blocks of said subset of blocks not belonging to said list of blocks received by said intermediate node so as to determine the blocks produced by said intermediate node on the communication path; and
entering a second tag including said blocks produced by said intermediate node.

Correspondingly, the present invention concerns a device for creating a description document in markup language of a global service provided by at least two successive nodes on a communication path in the communication network, from description documents of a unitary service supplied by each of the said nodes on the communication path, each description document of a unitary service supplied by a node comprising a list of blocks received by said node when said unitary service is implemented comprising:
means of determining a set of blocks comprising the combination of the blocks received by each node on the communication path when the global service is implemented;
means of entering a first tag including the said combination of the blocks received;
means of determining for each node the processing or processings associated respectively with the blocks of said combination of the blocks received; and
means of entering a second tag specifying the processing or processings associated with said blocks at each node on the communication path.

The present invention also concerns a device for identifying the blocks to be included in a message intended to pass over a communication path comprising at least two successive nodes of the communication network, from a description document of a global service supplied on said communication path, comprising:
means of determining all the blocks consumed by each node on the communication path;
means of determining all the blocks produced by each node on the communication path; and
means of identifying the blocks in said set of blocks consumed which do not belong to said set of blocks produced so as to determine the blocks to be entered in the message.

The invention also concerns a device for discovering work carried out by a node on a communication path in a communication network, from a description document of a global service supplied on said communication path, comprising:
means of reading for said node the processing or processings and said blocks associated with these processings specified in a tag of the description document of a global service;
means of reading the definition of said read blocks specified in another tag of the description document of a global service; and
means of supplying a response including the list of the read blocks associated respectively with said definition.

It also concerns a device for identifying the blocks sent by an intermediate node on a communication path in a communication network, from a description document of a global service supplied on said communication path, comprising:
means of determining the blocks sent by a sender according to the method of identifying the blocks to be included in a message according to the second aspect of the present invention;
means of determining all the blocks produced by nodes prior to said intermediate node on the communication path;
means of determining all the blocks consumed by said nodes prior to said intermediate node on the communication path;
means of determining said blocks produced by said intermediate node on the communication path;
means of determining said blocks consumed by said intermediate node on the communication path; and
means of identifying the blocks belonging to a first set containing all the blocks sent by the sender, the blocks produced by said prior nodes, and the blocks produced by said intermediate node, and not belonging to a second set containing the blocks consumed by said prior nodes and the blocks consumed by said intermediate node, so as to determine the blocks sent by said intermediate node.

Finally, the present invention concerns another embodiment of a device for creating a description document in markup language of a partial service supplied by an intermediate node on a communication path in a communication network when a global service supplied by at least two successive nodes on said communication path is implemented, from description documents of a unitary service provided for each node on the communication path, each description document of a unitary service provided by a node comprising a list of blocks received by said node when said unitary service is implemented, comprising:
means of reading the list of blocks received by said intermediate node from the description document of a unitary service associated with said intermediate node;
means of calculating a subset of blocks comprising the combination of the blocks received by the nodes following said intermediate node in the communication path;
means of identifying the blocks in said list of blocks received by said intermediate node not belonging to said subset of blocks so as to determine the blocks consumed by said intermediate node; and
means of entering a first tag including said blocks consumed by said intermediate node.

These creation devices, this device for identifying the blocks to be included in a message or sent by an intermediate node, and this device for discovering work carried out by an intermediate node have characteristics and advantages similar to those of the methods which they implement.

The present invention also concerns a server computer in a communication network comprising means adapted to implement a method of creating a document according to the first aspect or the sixth aspect of the present invention.

It also concerns a client computer in a communication network comprising means adapted to implement the method of identifying the blocks to be included in a message according to a second aspect of the invention.

More generally, it concerns a communication network adapted to implement the methods described above according to the various aspects of the invention.

Finally, it concerns a computer program which can be read by a microprocessor, comprising portions of software code adapted to implement the methods described above for the various aspects of the present invention, when this computer program is loaded in and executed by the microprocessor.

This server computer, client computer, communication network, and computer program have characteristics and advantages similar to those of the methods which they implement.

Other particularities and advantages of the invention will also emerge from the following description.

In the accompanying drawings given by way of non-limiting example:

FIGS. 1a and 1b illustrate the prior state of the art described previously;

FIG. 1c is a diagram illustrating the principle of a description document in markup language of a global service according to a first embodiment of the invention;

FIG. 1d illustrates the principle of a description document in markup language of a partial service according to a second embodiment of the invention;

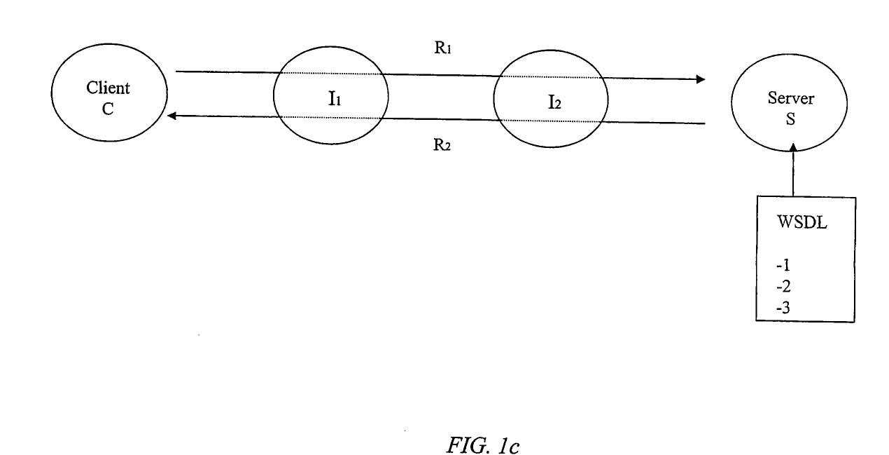

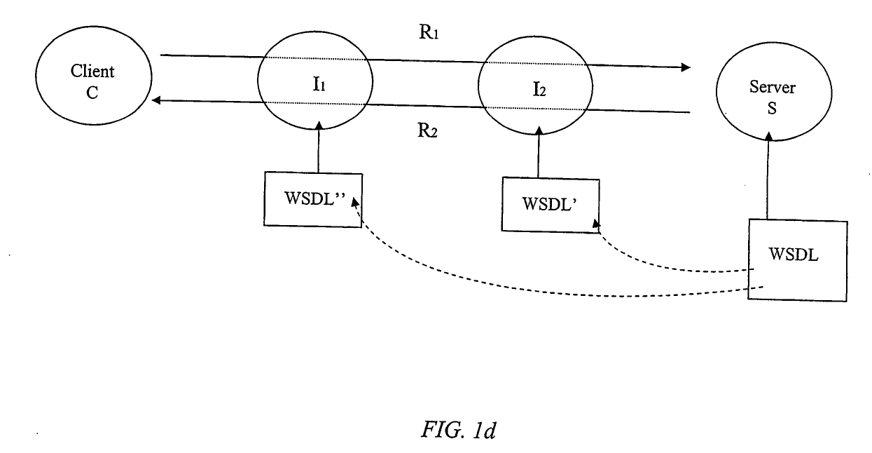

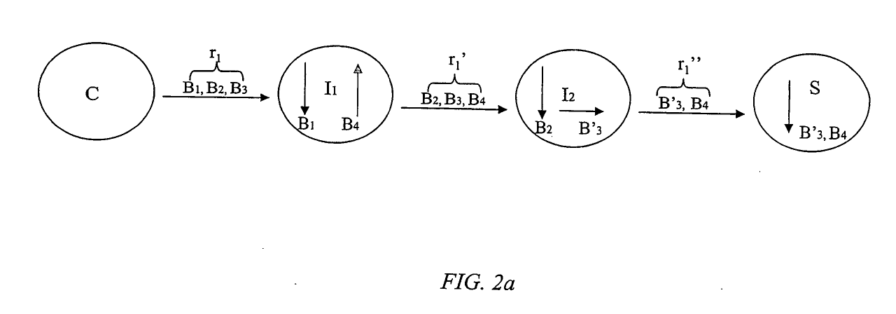

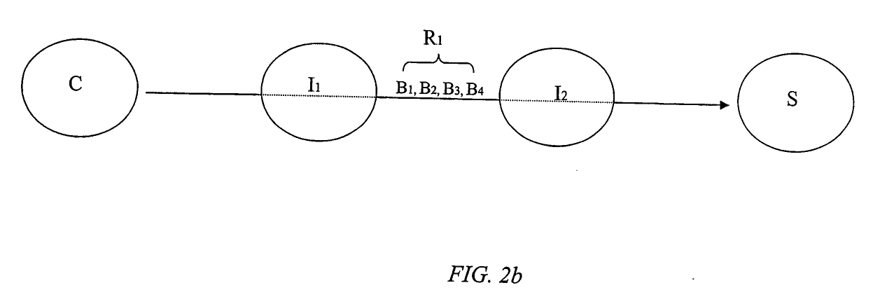

FIGS. 2a and 2b illustrate a practical case of the transfer of messages on a communication path in a communication network;

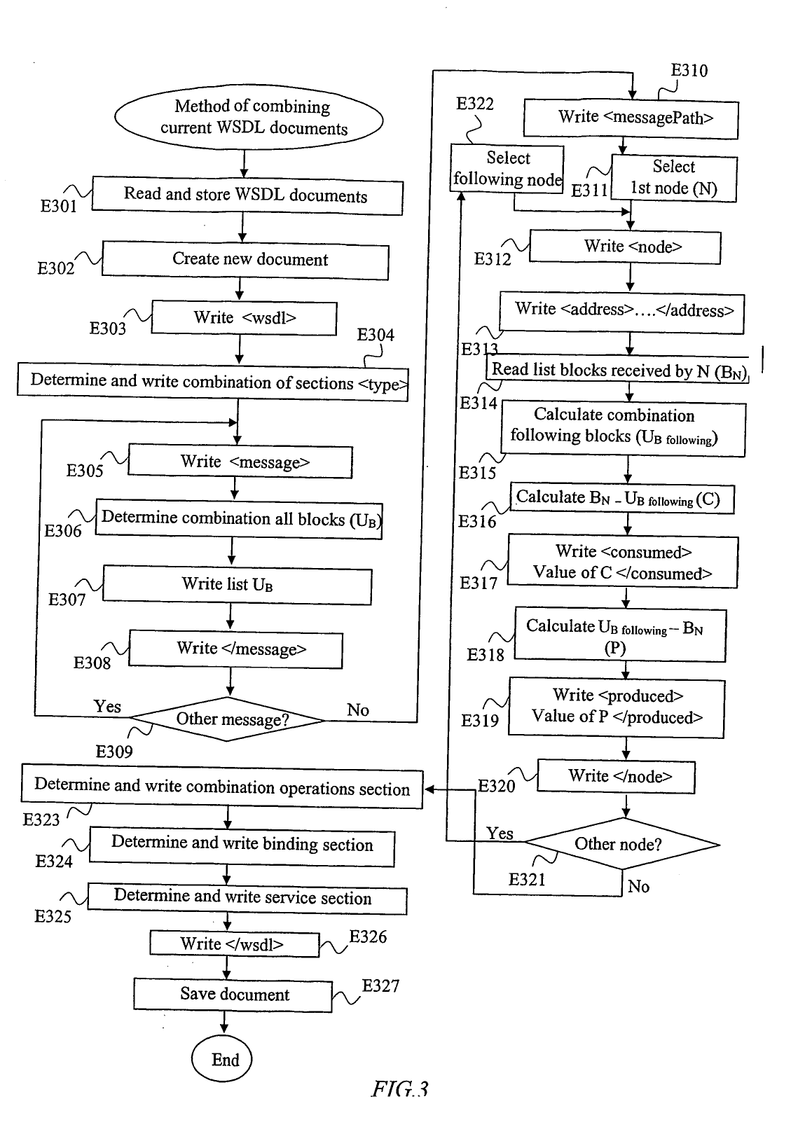

FIG. 3 illustrates a method of creating a description document in markup language of a global service according to one embodiment of the invention;

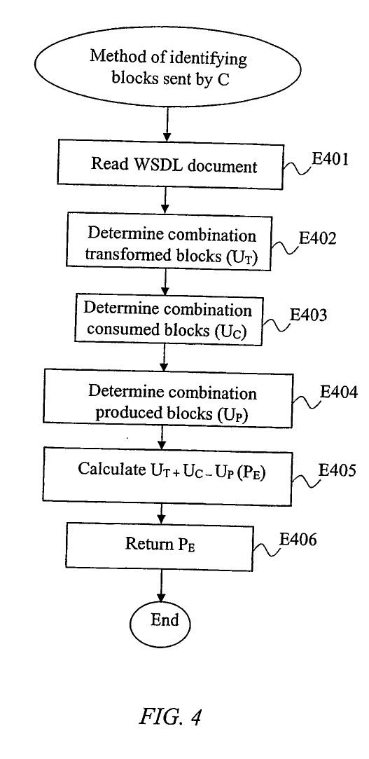

FIG. 4 illustrates a method of identifying the blocks to be included in a message according to one embodiment of the invention;

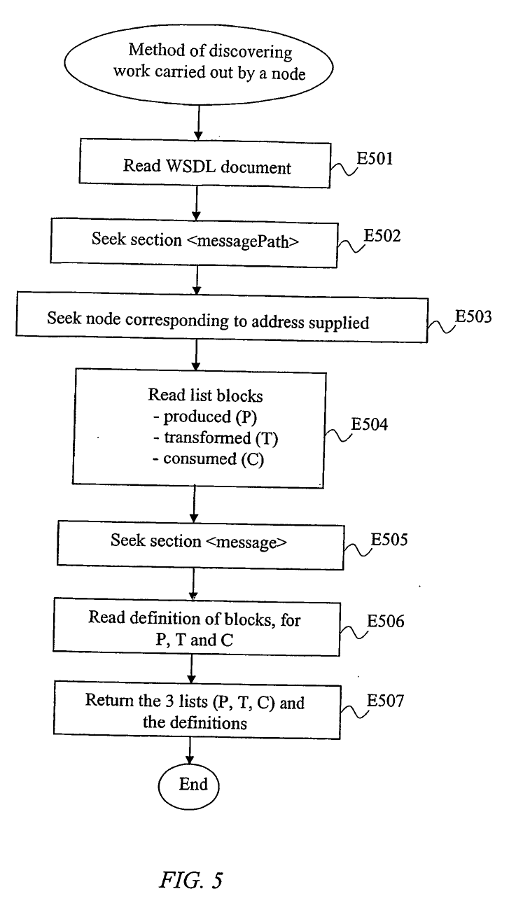

FIG. 5 is an algorithm illustrating a method of discovering work carried out by a node according to one embodiment of the invention;

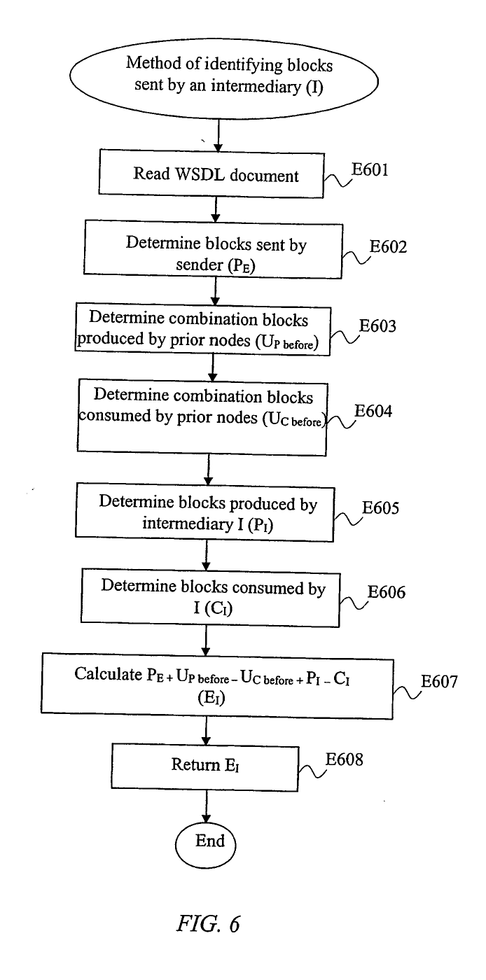

FIG. 6 is an algorithm illustrating a method of discovering blocks sent by an intermediate node according to one embodiment of the invention;

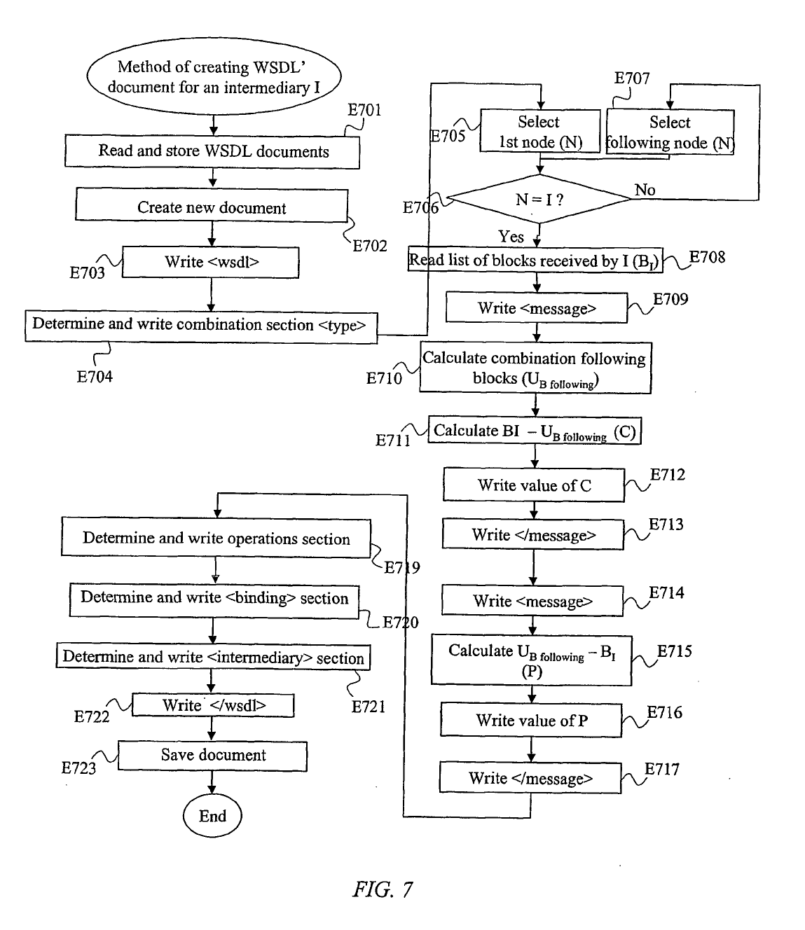

FIG. 7 is an algorithm illustrating a method of creating a description document in markup language of a partial service supplied by an intermediary according to one embodiment of the invention; and

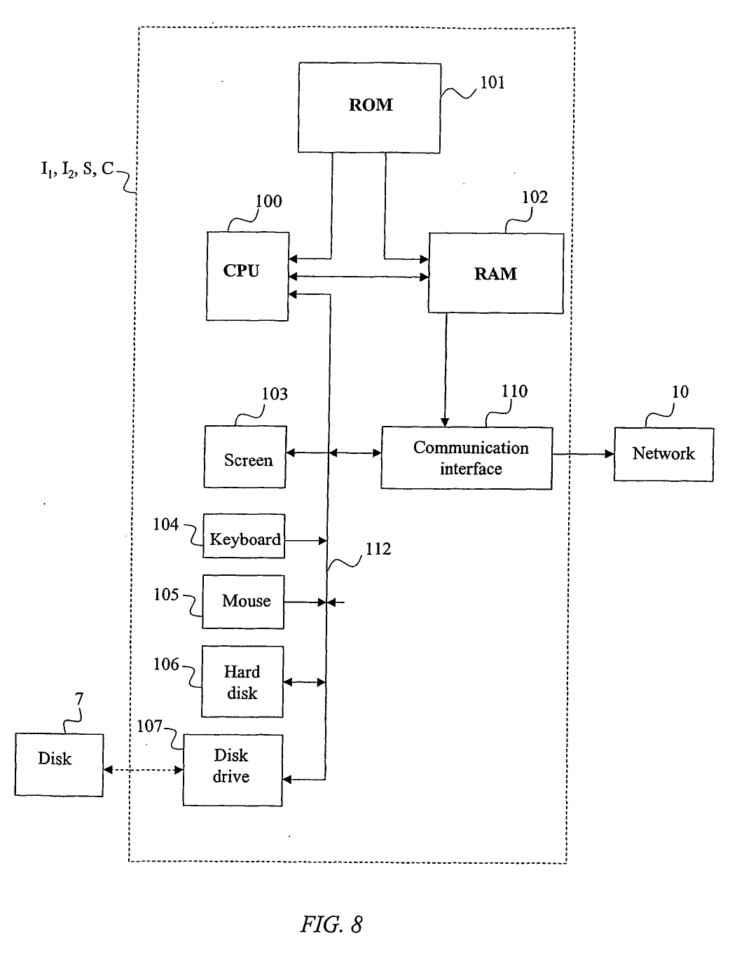

FIG. 8 is a block diagram illustrating a device adapted to implement the present invention.

The general principle of the present invention will first of all be described with reference to FIGS. 1c and 1d.

The particular case is adopted where a global service supplied on the communication network to a client C is implemented on a communication path comprising several intermediaries, here two intermediaries I1 and I2, for relaying the messages between the client C and a server S providing the main service.

By virtue of the invention, a description document in markup language of the global service is capable of describing the processings carried out by the various nodes I1, I2 and S in the communication network.

This global service, corresponding to the combination of the partial services supplied by each of the nodes I1, I2 and S, is described in a unique document WSDL, stored at the server S.

In the embodiment described in FIG. 1c, a unique document WSDL is stored at the server.

In a variant, this global document can be divided into several parts, a main part describing the service provided by the server S being stored at the server S and description documents of a partial service WSDL′ and WSDL″, for respectively describing services provided by the intermediaries I1, I2, are stored respectively at the intermediate nodes I1 and I2.

In general terms, the description documents in markup language according to the invention correspond to documents of the WSDL type, whose structure has been modified, in particular with regard to the content and semantics of the tag <message> and by the addition of a tag <messagePath>.

As illustrated in FIG. 1b, illustrating the prior state of the art, when a service is executed by the server S intended for the client C through the nodes I1 and I2, several individual messages r1, r1′, r1″ are exchanged on the communication network, from node to node on the communication path extending between the client C and the server S. These messages are in reality several variants over time of the same message, this message being successively modified by the various nodes on the communication path.

Thus, as illustrated in FIG. 1b, the client C sends a first message r1 to the server S. A first intermediate node I1 receives this message r1, modifies it and then retransmits this modified message r1′ to a second intermediate node I2. The latter receives this modified message r1′ and modifies it in its turn before retransmitting a message r1″ to the server S.

Thus the message r1 has had three different states, with modifications to blocks.

Hereinafter, it is considered that an intermediary in the communication network can perform various processings of the blocks of a message constructed according to the SOAP standard.

In particular, a node in the network can modify the blocks which are intended for it, process them and possibly generate new blocks.

The consumed blocks are definitively removed from the transmitted message; the produced blocks are added to the transmitted message; and if applicable any transformed blocks are erased and then reinserted in the transmitted message. These transformed blocks are for example blocks encrypted by an intermediate node in the communication network.

It will be noted in the remainder of the description that these transformed blocks can also be seen at a node as equivalent to a block consumed by a node and to a new block produced by this node in the message passing over the communication network.

Thus, referring to FIG. 1b, the message r1 has had various states on the communication path, with eliminations, additions and transformations of the blocks.

By way of example, the message as illustrated in the example in FIG. 2a can be considered.

The initial message r1 comprises three blocks, B1, B2, and B3. The intermediate node I1 consumes the block B1 and produces a new block B4, which is added to the message r1′, which then contains the blocks B2, B3, B4.

The intermediate node I2 receiving the modified message r1′ also consumes the block B2 and transforms the received block B3 into a new block B3′.

The message received by the server S then comprises the blocks B3′ and B4, which are consumed at the server.

According to the current state of the art, the WSDL standard provides for a description document of a service WSDL1, WSDL2, WSDL3 associated with each node in the communication network, and adapted to list in its tag <message> all the blocks which are received by this node.

Thus in particular this tag <message> lists the blocks which are received by the intermediate nodes I1, I2 as well as the blocks which are received and consumed by the server S.

An example is given below of the content of the tag <message> of a document WSDL1 to the format of the current WSDL standard:

...
<message name=“req-in”>

<part name=“B1”/>
<part name=“B2”/>
<part name=“B3”/>

</message>
<message name=“req-out”>

<part name=“B2”/>
<part name=“B3”/>
<part name=“B4”/>

</message>
<message name=“resp-in”>

<part name=“B5”/>

</message>
<message name=“resp-out”>

<part name=“B5”/>

</message>
<operation name=“request”>

<input ref=“req-in”/>
<output ref=“req-out”/>

</operation>
<operation name=“response”>

<input ref=“resp-in”/>
<output ref=“resp-out”/>

</operation>
...

Thus it is indicated above that two messages will pass over the network, one between the client C and the intermediate node I1 (“req-in”), the other between the intermediate nodes I1 and I2 (“req-out”). This is thus the request relayed by the intermediary I1.

Then two other messages will pass over the network, one between the intermediaries I2 and I1 (“resp-in”), the other between the intermediate node I1 and the client (“resp-out”). This is thus the response relayed by the intermediate node I1.

The response can consist, as in this example, of a unique block B5.

Such a description document of a service at the level of the intermediate document I1 does not make it possible to indicate a link existing between the two request messages and the two response messages.

According to the present invention, it is considered, as illustrated in FIG. 1c, that all the intermediate nodes I1, I2 and the server S on the communication path provide a global service described in a description document of a single WSDL service.

This description document of a service comprises first of all, in a first tag <message>, the combination of the blocks received by each node on the communication path.

Thus this tag <message> contains all the blocks contained at a given moment in the same message traveling on the communication path, that is to say the complete list of blocks produced, consumed or transformed by any one of the nodes on the communication path, independently of the node for which this block is intended.

Thus this amounts to considering not each message individually but the combination of individual messages in the same operation.

Thus the present invention consists of considering that there has been only one message R1 (see FIG. 2b), corresponding to the combination of all the other messages r1, r1′ and r1″, that is to say a message containing the list of all the blocks which have appeared in one or other of the messages r1, r1′ or r1″.

As illustrated in FIG. 2b, the combined message R1 comprises in the previous example illustrated in FIG. 2a four blocks B1, B2, B3 and B4.

This part of the improved WSDL description document corresponds to the following example:

<message>

<part name=“B1”/>
<part name=“B2”/>
<part name=“B3”/>
<part name=“B4”/>

</message>

It should be noted that a virtual message which does not exist at any time on the network is described above.

It is interesting to note that the description document of a conventional WSDL service for describing the service provided by the server S would have been as follows in the absence of the invention:

<message>

<part name=“B3”/>
<part name=“B4”/>

</message>

This is because the service provided by the server S would thus have been simply described, without referencing the services provided on the communication path by the intermediate nodes I1 and I2.

The description document of an improved WSDL service enables a client computer in particular to know, from the WSDL document, the blocks, here B1, B2 and B3, which must be integrated in a message intended for the server computer S.

In the absence of the present invention, the client computer will have believed, from a reading of the conventional WSDL document, that it had to send blocks B3 and B4.

It should be noted however that this first tag comprising the combination of the blocks received by each node on the communication path is not sufficient to describe the service provided in its entirety.

It is in fact necessary to indicate which nodes on the communication path must produce, consume and possibly transform one or other block in the message.

In this regard, the description document in markup language according to the invention comprises a second tag, called <messagePath>, for specifying for each block the processing or processings implemented and the identification of the node on the communication path adapted to process this block.

This second tag, which contains the addressing information, is preferably integrated in a concrete part of the WSDL document, adapted to describe the communication protocols used by the messages described in the abstract part of the document.

Naturally, it would if necessary be possible to annotate the tags <part> of the first tag <message> directly in the abstract part of the document.

By way of example, the content of the tag <messagePath> corresponding to the message described above may be as follows:

<messagePath>

<node>

<address>I1</address>
<consumes>B1</consumes>
<produces>B4</produces>
<transforms></transforms>

</node>
<node>

<address>I2</address>
<consumes>B2</consumes>
<produces></produces>
<transforms>B3</transforms>

</node>
<node>

<address>R</address>
<consumes>B3,B4</consumes>
<produces></produces>
<transforms></transforms>

</node>

</message>

The processings thus described in this second tag are chosen from amongst the processings which can be executed by the nodes in the communication network according to the SOAP standard.

In particular, the processing can correspond to the production of a block, to the consumption of a block or to the transformation of a block in a message passing over the communication path. The tag <messagePath> belongs conceptually to the coupling section <binding> of the WSDL document. It could possibly be attached to a section <service>.

However, in a preferential embodiment, it is advantageous to integrate this tag <messagePath> directly following the global section <message>.

There exists one section <message> per message passing over the network, an elementary operation corresponding in general to the combination of several messages.

Consequently there will be as many sections <messagePath> as there are sections <message>.

For this purpose, each section <messagePath> will point to the section <message> to which it applies.

In a conventional manner in an XML markup language, a reference will be associated with the second tag <messagePath>, via an attribute <ref> for identifying the first associated tag <message>.

The example presentation described above for the content of the second tag <messagePath> can possibly be modified as follows:

<messagePath>

<part ref=“B1”>

<consumed>I1</consumed>

</part>
<part ref=“B2”>

<consumed>I2</consumed>

</part>
<part ref=“B3”>

<transformed>I2</transformed>
<consumed>R</consumed>

</part>
<part ref=“B4”>

<consumed>R</consumed>

</part>

</message>

This type of presentation makes it possible to more easily describe the processings carried out, in the knowledge that one and the same node in the communication network can carry out several processings on a message and that these processings for one and the same node can vary over time.

It is thus preferable, unlike the previous example in which, for each node, the processings associated with the processed blocks are described, to describe on the other hand for each block the nodes adapted to perform a processing of this block.

Thus, in a unique description document of a service, the description of a global service provided on the communication network is obtained.

By way of variant, and as illustrated in FIG. 1d, this description file could be divided into several parts, a main part adapted to describe the service provided by the server computer S and one or more secondary parts describing the partial services provided by the intermediate nodes.

In the previous example, there exist two description documents of a partial service WSDL′ and WSDL″, respectively for the intermediate nodes I1 and I2.

In such a case, this description document of a service according to the invention makes it possible to describe only the work carried out by the intermediate node.

In particular, unlike the state of the art, and the document WSDL1 described previously, the blocks which are simply relayed by the intermediate node and are not processed at the node are not described in this description document of a partial service according to the invention.

Thus, at the first intermediate node I1, the part <message> of the description document of a WSDL′ service would be as follows:

<message name=“req-in”>

<part name=“B1”/>

</message>
<message name=“req-out”>

<part name=“B4”/>

</message>
<message name=“resp-in”>
</message>
<message name=“resp-out”>
</message>

Alternatively, it is possible to give only a description of the input messages of an intermediate node since the description of the output messages would be covered by the description document of a partial WSDL service of a second intermediary I2 or by the description of a global WSDL service associated with the server computer S.

The description document of a partial WSDL service at the node I1 can thus be as follows:

<message name=“req-in”>

<part name=“B1”/>

</message>
<message name=“resp-in”>
</message>

In addition, a tag <relay> is introduced at the tag <operation> in order to indicate that some messages are only relayed by the intermediary.

This is because a WSDL file is necessarily positioned from the point of view of the service provider. The tag <input> therefore indicates the messages coming from the client and the tag <output> the responses returned to this client.

Here the tag <relay> indicates the presence of a third distinct node of the client.

<operation name=“request-response”>

<input ref=“req-in”/>
<relay ref=“resp-out”/>
<relay ref=“resp-in”/>
<output ref=“resp-out”/>

</operation>

Finally, the name of the tag <service> is replaced with <intermediary> in order to indicate that the description is that of an intermediary and therefore does not list all the blocks relayed but only those processed by the intermediary.

In addition, the tag <soap:body> is enabled to be optional within the tag <soap:binding> since in fact the intermediaries do not process the body blocks.

In a variant, the tag <service> is kept but the tags <soap:binding> and <soap:header> are replaced respectively by <soap-intermediary:binding> and <soap-intermediary:header> in order to obtain the same effects as above.

A description will now be given with reference to FIG. 3 and according to a first aspect of the invention of a method of creating a description document in markup language of a global service provided as described previously.

Such a creation method corresponds to a judicious combination of the description documents of a unitary service provided by the various nodes on the communication path in a communication network.

An acquisition step E301 is adapted first of all to read and store the description documents of a unitary service provided respectively by the successive nodes of a communication path over which the messages pass when the global service is implemented.

It should be stated, as explained before, that each description document of a unitary service provided by a node comprises a list of the blocks received by this node when the unitary service is implemented.

A step E302 of creating a new description document of a WSDL service is then implemented.

In practice, there is first of all entered in a writing step E303 a tag <wsdl> at the header of the document and then a step of determining and entering E304 a section <type> is implemented. This section contains the combination of the sections <type> of the unitary description documents.

An entering step E305 is adapted to enter an opening tag <message>.

A step E306 of determining a set of blocks U_{B} makes it possible to determine the combination of blocks received by each node on the communication path when the global service is implemented.

As explained previously, this determination step E306 makes it possible to identify all the blocks which are at any time passing over the communication network when the message is transferred between the client computer and the server computer.

An entering step E307 makes it possible to enter this list U_{B} following the opening tag <message>.

Next, an entering step E308 is adapted to enter the closing tag </message>.

It is next checked in a test step E309 whether there exists another message definition in one of the unitary description documents.

In the affirmative, steps E305 to E308 are reiterated on this new message so that the document comprises as many tags <message> as there exist messages exchanged during the implementation of the service.

Next various steps are implemented to enable the entering of a second tag <messagePath> in order to specify the processings associated with each block and each node on the communication path.

In practice, an entering step E310 is adapted to enter an opening tag <messagePath>.

In a selection step E311, the first node N on the communication path is considered.

In the previous example, this node can be successively the intermediate nodes I1 and I2 and the server S.

In an entering step E312, an opening tag <node> is entered, describing this node.

For this purpose, a step E313 of entering a tag <address> is implemented in order to identify the electronic address of the node N. This address will be either the address of the node N in the communication path or an identifier for identifying the role played by this intermediary during the processing of a message.

A reading step E314 makes it possible to read the list of blocks B_{N} received by the node N, from the description document of a unitary service associated with this node N.

A calculation step E315 is adapted to calculate a subset of blocks U_{Bfollowing} comprising the combination of the blocks received by the nodes following the node N in the communication path.

This determination of the blocks received by the following nodes is also made from each description document of a unitary service associated with each node following the node N in question.

An identification step E316 is implemented by calculating the difference between the list of blocks received B_{N} and the combination of the following blocks U_{Bfollowing}.

In this way the blocks C consumed by the node N are identified by determining the blocks in the list B_{N} which do not belong to the subset of blocks U_{Bfollowing}.

An entering step E317 is adapted to enter a tag <consumed> for identifying a processing in which the blocks are consumed, this tag having the value C of the consumed blocks determined at the previous step E316.

A second identification step E318 is implemented in order to identify the blocks produced by the node N.

In practice, the difference between the combination of the following blocks U_{Bfollowing} and the list of blocks B_{N} received by the node is calculated.

The blocks P produced by the node N thus correspond to the blocks in the subset U_{Bfollowing} which do not belong to the list of blocks B_{N} received by the node N.

An entering step E319 is then implemented in order to enter a tag <produced> for specifying a processing during which blocks are produced, this tag having as its value the set P of produced blocks determined at the previous step E318.

A step E320 of entering a closing tag </node> is then implemented in order to close this tag making it possible to specify the processings associated with the blocks at each node on the communication path.

In a test step E321 it is then checked whether there exists another intermediate or final node on this communication path. In the affirmative, a selection step E322 selects the following node and all of steps E312 to E321 are reiterated for this new node. When at the end of the test step E321 all the nodes on the communication path have been examined, the writing of the WSDL document can continue in a conventional manner with a step E323 of determining and entering a section describing the operations implemented in the global service, corresponding to the combination of the sections <operation> described in the description documents of a unitary service associated respectively with each node on the communication path.

In this embodiment, the tag <messagePath> referencing the processings of each block at each node on the communication path is integrated in the abstract part of the description document of a service.

Naturally this tag <messagePath> could be introduced in the concrete part of the document, and more particularly in the coupling section <binding>.

In practice, the method of creating a description document of a service described in FIG. 3 continues with a step E324 of determining and entering a coupling section <binding> and then a step E325 of determining and describing a section <service> describing the service, both obtained by combining the sections <binding> and <service> respectively of the unitary description documents.

A step E326 of entering a closing tag </wsdl> is then implemented in order to terminate this document.

A saving step E327 stores this description document of a service in a conventional manner in a memory of the server computer S.

This algorithm thus makes it possible to combine several conventional WSDL files, associated respectively with a node on the communication path, in a unique document according to the invention.

It should be noted that this document transformation algorithm, in the absence of additional information, is not capable of automatically identifying the transformed blocks, such as the block B3 in the example described above with reference to FIG. 2a.

This is because, in such a case, the method of creating a document will consider that it is a case of two independent blocks, a first block being consumed by the node and a second block being produced by this node without a causality link being able to be established between these two blocks.

The method of creating a description document is preferably implemented in the order of the nodes present on the communication path in the communication network.

A description will now be given with reference to FIG. 4 of a method of identifying the blocks to be included in a message, that is to say the blocks sent by the client computer C for implementing a global service as described in a description document of a global service according to the invention.

A reading step E401 is first of all implemented in order to read the information described in this description document of a global WSDL service.

A step of determining all the blocks U_{T} transformed by each node on the communication path is implemented.

It should be noted that this step can possibly be omitted when the only processings appearing in the WSDL document are processings for consuming or producing blocks.

A step E403 of determining all the blocks U_{C} consumed by each node on the communication path is then implemented, as well as a step E404 of determining all the blocks U_{P} produced by each node on the communication path.

In practice, this determination of the blocks consumed U_{C} and the blocks produced U_{P} is made from information stored in the tag <messagePath> of the description document of a service according to the invention.

A step of identifying the blocks P_{E} to be entered in the message is then implemented by calculating the difference between the blocks belonging to the combination of the consumed blocks U_{C} and possibly to the combination of the transformed blocks U_{T}, and not belonging to the set of blocks produced U_{P}. The blocks to be sent are in fact the blocks which will be consumed or transformed along the communication path, but not produced by one of the nodes on this path.

This identification step E405 thus identifies the blocks P_{E} which are to be entered in the message in order to implement a global service on the communication path.

This method of identifying the blocks P_{E} can end in a step E406 of sending the list of blocks P_{E} thus identified, in particular for the attention of the client computer C.

Alternatively, the list of blocks P_{E} can be transmitted to a programming aid tool for the automatic generation of a message to the correct format. This list can also be displayed directly to the user for consultation.

It should be noted that this method of identifying the blocks can be implemented either at the server S, using the WSDL document which it is storing, or directly at the client computer C, after reception of the WSDL document supplied by the server computer S.

A description will now be given, according to another aspect of the invention, of a method of discovering work carried out by a node on the communication path, also implemented using the description document of a global service according to the invention.

As illustrated in FIG. 5, a reading step E501 is first of all implemented in order to acquire and read the content of the description document of a global WSDL service.

A step E502 of seeking the section of this document containing the tag <messagePath> is then implemented in order to identify the section of the document describing the various processings carried out by the nodes on the communication path.

A search step E503 is then adapted to seek, in this tag <messagePath>, the node corresponding to the address supplied, for which the work to be carried out is to be identified.

A reading step E504 is adapted to read for this node the processing or processings and the list of blocks associated with this processing.

In particular, the produced blocks P, the consumed blocks C and possibly the transformed blocks T are identified.

A search step E505 is then implemented in order to define the section <message> in the description document of the global service.

In particular, when there exist several tags <message>, the identification of the corresponding tag can be made by means of a pointer provided at the tag <messagePath>. Conventionally, this pointer can consist of a reference introduced into the tag <messagePath> by means of an attribute “ref”.

A reading step E506 reads in the tag <message> the definition of the blocks read previously, that is to say the produced P, transformed T or consumed C blocks.

A step E507 of supplying a response including the list of the read blocks associated respectively with the definitions is then implemented.

This supply step E507 displays for example at the intermediate node only the blocks and processings associated with this node from the description document of a global service provided on the communication path.

Alternatively, this information can be used by an intermediate node test tool in order to check for example that the node is processing the blocks of a test message in a manner in accordance with the description of the global service.

A description will now be given with reference to FIG. 6 of a method of identifying the blocks sent by an intermediate node from a description document of a global service according to the invention.

A reading step E601 acquires and reads the description document of a global WSDL service.

A determination step E602 first of all calculates the blocks P_{E} sent by a sender, typically the client computer C.

This step of determining the blocks sent P_{E} is implemented using the method of identifying the blocks to be included in a message as described previously with reference to FIG. 4.

Next a step E603 of determining all the blocks produced by nodes prior to the intermediate node in question I is implemented.

This step E603 of determining the blocks produced by the prior nodes U_{Pbefore} is implemented by means of the information stored in the section <messagePath> of the description document of a service, in the sections <produced> of the previous nodes on the communication path.

In a similar manner, a determination step E604 is implemented in the same way in order to determine the combination of the blocks consumed U_{Cbefore} by the nodes prior to the intermediate node in question I.

A step E605 of determining the blocks P_{I} produced by the intermediate node is also implemented, still from the information stored in the description document of a service (section <messagePath>, subsection <produced> of the intermediate node).

Likewise, a step E606 of determining the blocks C_{I} consumed by the intermediate node I is implemented (section <messagePath>, subsection <consumed> of the intermediate node).

From these elements, it is possible, in an identification step E607, to determine the blocks E_{I} sent or resent by the intermediate node I. In practice these blocks E_{I} correspond to the blocks belonging to a first set containing the blocks P_{E} sent by the sender, the blocks P_{I} produced by the intermediate node I and the blocks U_{Pbefore} produced by the prior nodes, not belonging to a second set containing the blocks U_{Cbefore} consumed by the prior nodes and the blocks C_{I} consumed by the intermediate node I.

This set of blocks thus determined E_{I} can then be sent in a sending step E608 over the communication network, for the attention of a server computer for example, or be displayed on a screen associated with a computer. This information can also serve as before to verify the correct functioning of an intermediate node.

Another embodiment of a method of creating a description document of a service will finally be described with reference to FIG. 7.

This is here a description document of a partial service WSDL′, associated with an intermediate node on the communication path as described previously with reference to FIG. 1d.

An acquisition step E701 is adapted first of all to read and store the description documents of a unitary service provided respectively by the successive nodes on a communication path over which the messages pass when the global service is implemented.

It should be stated as explained before that each description document of a unitary service provided by a node comprises a list of the blocks received by this node when the unitary service is implemented.

A step E702 of creating a new description document of a service WSDL′ is then implemented.

In practice, a tag <wsdl> at the head of the document is first of all entered in a writing step E703 and then a step E704 of determining and entering a section <type> is implemented. As before, this section is the combination of the sections of the unitary description documents.

First of all a first node N is selected in a selection step E705 and it is checked in a test step E706 whether it is a case of the intermediate node I for which it is wished to establish the document WSDL′. If not, the following node is selected in a selection step E707. When it is a case of the intermediate node I, a reading step E708 is adapted to read the list of blocks B, received by the node I from the description document of a unitary service.

Next an entry step E709 is adapted to enter an opening tag <message>.

A calculation step E710 is adapted to calculate a subset of blocks U_{Bfollowing} comprising the combination of blocks received by the nodes following the node I in the communication path.

This determination of the blocks received by the following nodes is also performed using each description document of a unitary service associated with each node following the node I in question.

An identification step E711 is implemented by calculating the difference between the list of blocks received BI and the combination of the following blocks U_{Bfollowing}.

In this way the blocks C consumed by the node I are identified by determining the blocks in the list B_{I} which do not belong to the subset of blocks U_{Bfollowing}.

An entry step E712 is adapted to enter the value C of the consumed blocks determined at the previous step E711.

A step E713 of entering a closing tag </message> is implemented in order to close the message tag. This tag corresponds to the message received by the intermediate node I. In the example in FIG. 2a, it is the message r1.

A second opening tag <message> is then entered in an entry step E714.

A second identification step E715 is implemented in order to identify the products produced by the node I.

In practice, the difference between the combination of the following blocks U_{Bfollowing} and the list of blocks B_{I} received by the node I is calculated.

The blocks P produced by the node I thus correspond to the blocks in the subset U_{Bfollowing} which do not belong to the list of blocks B_{I} received by the node I.

An entry step E716 is then implemented in order to enter the value of the set P of produced blocks determined at the previous step E715.

A step E717 of entering a closing tag </message> is then implemented in order to close this tag. This tag corresponds to the message relayed by the intermediate node I. In the example in FIG. 2a, it is the message r′1.

The writing of the document WSDL′ can continue in a conventional manner by means of a step E719 of determining and entering a section describing the operations implemented in the global service, corresponding to the combining of the sections <operation> described in the description documents of a unitary service associated respectively with each node on the communication path.

In practice, the method of creating a description document of a service described in FIG. 7 continues with a step E720 of determining and entering a coupling section <binding>, and then a step E721 of determining and describing a section <intermediary> specifying that the document WSDL′ is not a complete description document of a global service but only a partial service.

A step E722 of entering a closing tag </wsdl> is then implemented in order to terminate this document.

A saving step E723 stores this description document of a service in a conventional manner in a memory of the intermediate computer I.

In order to implement the methods of creating a description document in markup language of a global service, of identifying the blocks to be included in a message intended to pass over a communication path, of discovering work carried out by a node on a communication path in a communication network, of identifying the blocks sent by an intermediate node on a communication path in a communication network and of creating a description document in markup language of a partial service, the devices associated with these methods can be incorporated in a computer as illustrated in FIG. 8.

In particular, the devices for creating a description document of a global or partial service can be incorporated in a server computer S in a communication network whilst the device identifying the blocks to be included in a message intended to pass over a communication path can be incorporated in a client computer C in a communication network.

Naturally, the devices intended to implement the various methods of the present invention can be used in one and the same computer or in different stations in the communication network.

More precisely, the various means adapted to implement the steps of the methods according to the invention can be incorporated in a microprocessor 100, a read only memory 101 (or ROM) being adapted to store a program for creating a description document in markup language of a global service, for identifying blocks to be included in a message intended to pass over a communication path, for discovering work carried out by a node on a communication path in a communication network, for identifying the blocks sent by an intermediate node on a communication path in a communication network and for creating a description document in markup language of a partial service.

A random access memory 102 (or RAM) is adapted to store in registers the values modified during the execution of the program for creating a description document in markup language of a global service, for identifying blocks to be included in a message intended to pass over a communication path, for discovering work carried out by a node on a communication path in a communication network, for identifying the blocks sent by an intermediate node on a communication path in a communication network and for creating a description document in markup language of a partial service.

The microprocessor 100 is integrated in a computer, which can be connected to various peripherals and to other computers in a communication network 10. In particular, this computer corresponds to a server computer S, a client computer C or an intermediate computer I1, I2 in this communication network 10.

This computer S, C, I1, I2 comprises in a known manner a communication interface 110 connected to the communication network in order to receive or transmit messages.

The computer also comprises document storage means, such as a hard disk 106, or is adapted to cooperate by means of a disk drive 107 (diskettes, compact disks or computer cards) with removable document storage means, such as disks 7. These fixed or removable storage means can include the code of the methods according to the invention.

They are also adapted to store an electronic description document of a service as defined by the present invention.

By way of variant, these programs can be stored in the read only memory 101.

In a second variant, these programs can be received in order to be stored as described previously by means of the communication network 10.

The computer S, C, I1, I2 also possesses a screen 103 for serving for example as an interface with an operator by means of the keyboard 104 or the mouse 105 or any other means.

The central unit 100 (CPU) will then execute the instructions relating to the implementation of the invention. On powering up, the programs and methods relating to the invention stored in a non-volatile memory, for example the memory 101, are transferred into the memory 102, which will then contain the executable code of the invention as well as the variables necessary for implementing the invention.

The communication bus 112 affords communication between the various sub-elements of the computer or connected to it.

The representation of this bus 112 is not limiting and in particular the microprocessor 100 is able to communicate instructions to any sub-element directly or by means of another sub-element.

Naturally many modifications can be made to the example embodiments described above without departing from the scope of the invention.

1. A method of creating a description document in markup language of a global service provided by at least two successive nodes on a communication path in the communication network, from description documents of a unitary service supplied by each of the said nodes on the communication path, each description document of a unitary service supplied by a node comprising a list of blocks received by said node when said unitary service is implemented, comprising the following steps:
determining a set of blocks comprising the combination of the blocks received by each node on the communication path when the global service is implemented;
entering a first tag including the said combination of the blocks received;
determining for each node the processing or processings associated respectively with the blocks of the said combination of the blocks received; and
entering a second tag specifying the processing or processings associated with the said blocks at each node on the communication path.

2. A creation method according to claim 1, wherein the step of determining the processing or processings comprises, for each node on the communication path, the following steps:
reading the list of blocks received by said node from the unitary service description document associated with said node;
calculating a subset of blocks comprising the combination of the blocks received by the nodes following said node in the communication path; and
identifying the blocks in the list not belonging to said subset of blocks so as to determine the blocks consumed by said node.

3. A creation method according to claim 1, wherein the step of determining the processing or processings comprises, for each node on the communication path, the following steps:
reading the list of blocks received by said node from the unitary service description document associated with said node;
calculating a subset of blocks comprising the combination of the blocks received by the nodes following said node in the communication path; and
identifying the blocks in said subset of blocks not belonging to said list of blocks received by said node so as to determine the blocks produced by said node on the communication path.

4. A creation method according to claim 1, wherein said second tag is adapted to specify a processing chosen from amongst the production of a block, the consumption of a block or the transformation of a block of a message passing over the communication path.

5. A creation method according to claim 1, in which the global service provided comprises several messages passing over the communication path, characterized in that it comprises, for each message described in the description document in markup language, a step of entering a first tag including the combination of the blocks received during the transfer of said message and a step of entering a second tag specifying the processing or processings associated with said blocks of said combination at each node on the communication path.

6. A creation method according to claim 5, wherein, for each message, said second tag is associated with a reference identifying said first tag.

7. A method of identifying the blocks to be included in a message intended to pass over a communication path comprising at least two successive nodes of the communication network, from a description document of a global service supplied on said communication path, comprising the following steps:
determining all the blocks consumed by each node on the communication path;
determining all the blocks produced by each node on the communication path; and
identifying the blocks in said set of blocks consumed which do not belong to said set of blocks produced so as to determine the blocks to be entered in the message.

8. A method of discovering work carried out by a node on a communication path in a communication network, from a description document of a global service supplied on said communication path, comprising the following steps:
reading for said node the processing or processings and said blocks associated with these processings specified in a tag of the description document of a global service;
reading the definition of said read blocks specified in another tag of the description document of a global service; and
supplying a response including the list of the read blocks associated respectively with said definitions.

9. A method of identifying the blocks sent by an intermediate node on a communication path in a communication network, from a description document of a global service supplied on said communication path, comprising the following steps:
determining the blocks sent by a sender according to the method of identifying the blocks to be included in a message according to claim 7;
determining all the blocks produced by nodes prior to said intermediate node on the communication path;
determining all the blocks consumed by said nodes prior to said intermediate node on the communication path;
determining said blocks produced by said intermediate node on the communication path;
determining said blocks consumed by said intermediate node on the communication path; and
identifying the blocks belonging to a first set containing all the blocks sent by the sender, the blocks produced by said prior nodes, and the blocks produced by said intermediate node, and not belonging to a second set containing all the blocks consumed by said prior nodes and the blocks consumed by said intermediate node, so as to determine the blocks sent by said intermediate node.

10. A description document in markup language of a global service provided by at least two successive nodes on a communication path in the communication network, comprising a first tag comprising the combining of the blocks received by each node and a second tag specifying respectively for said blocks the processings implemented and the identification of said node on the communication path adapted to process said block.

11. A description document according to claim 10, wherein the processing is chosen from amongst the production of a block, the consumption of a block or the transformation of a block of a message passing over the communication path.

12. A description document according to claim 10, wherein said second tag is associated with a reference identifying a first tag.

13. A description document according to claim 10, wherein it is presented in a format of the WSDL type.

14. A method of creating a description document in markup language of a partial service supplied by an intermediate node on a communication path in a communication network when a global service supplied by at least two successive nodes on said communication path is implemented, from description documents of a unitary service provided by each node on the communication path, each description document of a unitary service provided by a node comprising a list of blocks received by said node when said unitary service is implemented, comprising the following steps:
reading the list of blocks received by said intermediate node from the description document of a unitary service associated with said intermediate node;
calculating a subset of blocks comprising the combination of the blocks received by the nodes following said intermediate node in the communication path;
identifying the blocks in said list of blocks received by said intermediate node not belonging to said subset of blocks so as to determine the blocks consumed by said intermediate node; and
entering a first tag including said blocks consumed by said intermediate node.

15. A method of creating a document according to claim 14, wherein it also comprises the following steps:
identifying the blocks of said subset of blocks not belonging to said list of blocks received by said intermediate node so as to determine the blocks produced by said intermediate node on the communication path; and
entering a second tag including said blocks produced by said intermediate node.

16. A device for creating a description document in markup language of a global service provided by at least two successive nodes on a communication path in the communication network, from description documents of a unitary service supplied by each of the said nodes on the communication path, each description document of a unitary service supplied by a node comprising a list of blocks received by said node when said unitary service is implemented comprising:
means of determining a set of blocks comprising the combination of the blocks received by each node on the communication path when the global service is implemented;
means of entering a first tag including the said combination of the blocks received;
means of determining for each node the processing or processings associated respectively with the blocks of the said combination of the blocks received; and
means of entering a second tag specifying the processing or processings associated with the said blocks at each node on the communication path.

17. A creation device according to claim 16, comprising:
means of reading the list of blocks received by said node from the unitary service description document associated with said node;
means of calculating a subset of blocks comprising the combination of the blocks received by the nodes following said node in the communication path; and
means of identifying the blocks in the list not belonging to said subset of blocks so as to determine the blocks consumed by said node.

18. A creation device according to claim 16, comprising:
means of reading the list of blocks received by said node from the unitary service description document associated with said node;
means of calculating a subset of blocks comprising the combination of the blocks received by the nodes following said node in the communication path; and
means of identifying the blocks in said subset of blocks not belonging to said list of blocks received by said node so as to determine the blocks produced by said node on the communication path.

19. A device for identifying the blocks to be included in a message intended to pass over a communication path comprising at least two successive nodes of the communication network, from a description document of a global service supplied on said communication path, comprising:
means of determining all the blocks consumed by each node on the communication path;
means of determining all the blocks produced by each node on the communication path; and
means of identifying the blocks in said set of blocks consumed which do not belong to said set of blocks produced so as to determine the blocks to be entered in the message.

20. A device for discovering work carried out by a node on a communication path in a communication network, from a description document of a global service supplied on said communication path, comprising:
means of reading for said node the processing or processings and said blocks associated with these processings specified in a tag of the description document of a global service;
means of reading the definition of said read blocks specified in another tag of the description document of a global service; and
means of supplying a response including the list of the read blocks associated respectively with said definition.

21. A device for identifying the blocks sent by an intermediate node on a communication path in a communication network, from a description document of a global service supplied on said communication path, comprising:
means of determining the blocks sent by a sender according to the method of identifying the blocks to be included in a message according to claim 7;
means of determining all the blocks produced by nodes prior to said intermediate node on the communication path;
means of determining all the blocks consumed by said nodes prior to said intermediate node on the communication path;
means of determining said blocks produced by said intermediate node on the communication path;
means of determining said blocks consumed by said intermediate node on the communication path; and
means of identifying the blocks belonging to a first set containing all the blocks sent by the sender, the blocks produced by said prior nodes, and the blocks produced by said intermediate node, and not belonging to a second set containing all the blocks consumed by said prior nodes and the blocks consumed by said intermediate node, so as to determine the blocks sent by said intermediate node.

22. A device for creating a description document in markup language of a partial service supplied by an intermediate node on a communication path in a communication network when a global service supplied by at least two successive nodes on said communication path is implemented, from description documents of a unitary service provided for each node on the communication path, each description document of a unitary service provided by a node comprising a list of blocks received by said node when said unitary service is implemented, comprising:
means of reading the list of blocks received by said intermediate node from the description document of a unitary service associated with said intermediate node;
means of calculating a subset of blocks comprising the combination of the blocks received by the nodes following said intermediate node in the communication path;
means of identifying the blocks in said list of blocks received by said intermediate node not belonging to said subset of blocks so as to determine the blocks consumed by said intermediate node; and
means of entering a first tag including said blocks consumed by said intermediate node.

23. A creation device according to claim 22, also comprising:
means of identifying the blocks of said subset of blocks not belonging to said list of blocks received by said intermediate node so as to determine the blocks produced by said intermediate node on the communication path; and
means of entering a second tag including said blocks produced by said intermediate node.

24. A server computer in a communication network, comprising means adapted to implement the method of creating a document according to claim 1.

25. A server computer in a communication network, comprising means adapted to implement the method of creating a document according to claim 14.

26. A client computer in a communication network, comprising means adapted to implement the method of identifying blocks to be included in a message according to claim 7.

27. A communication network, comprising means adapted to implement the document creation method according to claim 1.

28. A computer program which can be read by a microprocessor, comprising portions of software code adapted to implement the method of creating a description document of a global service according to claim 1, when this computer program is loaded in and executed by the microprocessor.

29. A computer program which can be read by a microprocessor, comprising portions of software code adapted to implement the method of identifying the blocks to be included in a message according to claim 7, when this computer program is loaded in and executed by the microprocessor.

30. A computer program which can be read by a microprocessor, comprising portions of software code adapted to implement the method of discovering work in accordance with claim 8, when this computer program is loaded in and executed by the microprocessor.

31. A computer program which can be read by a microprocessor, comprising portions of software code adapted to implement the method of identifying the blocks sent by an intermediate node according to claim 9, when this computer program is loaded in and executed by the microprocessor.

32. A computer program which can be read by a microprocessor, comprising portions of software code adapted to implement the method of creating a description document of a partial service according to claim 14, when this computer program is loaded in and executed by the microprocessor.
